(19) United States
(12) Patent Application Publication
(10) Pub. No.: US 2026/0244708 A1
(43) Pub. Date: Aug. 20, 2026

(54) INFORMATION PROCESSING DEVICE, INFORMATION PROCESSING METHOD, AND NON-TRANSITORY COMPUTER-READABLE MEDIUM

(71) Applicant: NEC Corporation, Tokyo (JP)

(72) Inventors: Takahiro MURAMATSU, Tokyo (JP); Motonori IKEUCHI, Tokyo (JP); Yuzuru OKAJIMA, Tokyo (JP)

(73) Assignee: NEC Corporation, Tokyo (JP)

(21) Appl. No.: 19/535,188

(22) Filed: Feb. 10, 2026

(30) Foreign Application Priority Data
Feb. 20, 2025 (JP) 2025-025945

(51) Int. Cl. G06F 18/213; G06N 5/025

(52) U.S. Cl. CPC G06F 18/213; G06N 5/025

(57) ABSTRACT

An information processing device according to the present disclosure includes at least one memory storing instructions, and at least one processor configured to execute the instructions to acquire a data set of data including a plurality of feature values indicating features relating to an event and a plurality of evaluation values for the event, and calculate, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

### INCORPORATION BY REFERENCE

This application is based upon and claims the benefit of priority from Japanese patent application No. 2025-025945, filed on Feb. 20, 2025, the disclosure of which is incorporated herein in its entirety by reference.

### TECHNICAL FIELD

The present disclosure relates to an information processing device, an information processing method, and a non-transitory computer-readable medium.

### BACKGROUND ART

JP 2009-076014 A discloses a technique for determining a value of an explanatory variable that gives an appropriate value of a physical quantity, based on a first evaluation value indicating a degree of discrepancy between a value of the physical quantity with respect to a candidate value and a target value, and a second evaluation value indicating a degree of discrepancy between a gradient value of the physical quantity with respect to the candidate value and the target value.

### SUMMARY

However, in the technique described in JP 2009-076014 A, for example, it has not been studied as to allowing a designer to appropriately consider each design value that achieves each performance value.

In view of the above-mentioned problems, an example object of the present disclosure is to provide a technique that allows a designer to appropriately consider each design value that achieves each performance value.

According to a first example aspect of the present disclosure, there is provided an information processing device including an acquisition unit that acquires a data set of data including a plurality of feature values indicating features relating to an event and a plurality of evaluation values for the event, and a calculation unit that calculates, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

According to a second example aspect of the present disclosure, there is provided an information processing device including an acquisition unit that acquires a data set of data including a plurality of feature values indicating features relating to an event and a plurality of evaluation values for the event, and a calculation unit that calculates, based on the data set, a degree of influence of each of a first feature and a second feature included in the plurality of feature values on each of the plurality of evaluation values for the event.

According to a third example aspect of the present disclosure, there is provided an information processing method including acquiring a data set of data including a plurality of feature values indicating features relating to an event and a plurality of evaluation values for the event, and calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

According to a fourth example aspect of the present disclosure, there is provided an information processing method including acquiring a data set of data including a plurality of feature values indicating features relating to an event and a plurality of evaluation values for the event, and calculating, based on the data set, a degree of influence of each of a first feature and a second feature included in the plurality of feature values on each of the plurality of evaluation values for the event.

According to a fifth example aspect of the present disclosure, there is provided a program for causing a computer to execute a process including acquiring a data set of data including a plurality of feature values indicating features relating to an event and a plurality of evaluation values for the event, and calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

According to a sixth example aspect of the present disclosure, there is provided a program for causing a computer to execute a process including acquiring a data set of data including a plurality of feature values indicating features relating to an event and a plurality of evaluation values for the event, and calculating, based on the data set, a degree of influence of each of a first feature and a second feature included in the plurality of feature values on each of the plurality of evaluation values for the event.

According to one mode, a designer is allowed to appropriately consider each design value that achieves each performance value.

### BRIEF DESCRIPTION OF THE DRAWINGS

FIG. 1 is a diagram illustrating an example of a configuration of an information processing device according to an example embodiment;

FIG. 2 is a diagram illustrating a hardware configuration example of the information processing device according to the example embodiment;

FIG. 3 is a flowchart illustrating an example of a process of the information processing device according to the example embodiment;

FIG. 4 is a diagram illustrating an example of information stored in an evaluation value database (DB) according to the example embodiment;

FIG. 5 is a diagram illustrating an example of a process for generating a data set according to the example embodiment;

FIG. 6 is a diagram illustrating an example of a display screen according to the example embodiment; and

FIG. 7 is a diagram illustrating an example of a display screen according to the example embodiment.

### EXAMPLE EMBODIMENT

The principles of the present disclosure will be described with reference to several illustrative example embodiments. It is to be understood that the example embodiments have been described for purposes of exemplification only and will aid those of ordinary skill in the art in understanding and carrying out the present disclosure, without suggesting any limitations on the scope of the present disclosure. The disclosure described in the present specification is implemented in various methods other than those to be described below.

In the following description and claims, unless defined otherwise, all technical and scientific terms used in the present specification have the same meaning as commonly understood by those of ordinary skill in the art of the technical field to which the present disclosure belongs.

Hereinafter, example embodiments of the present disclosure will be described with reference to the drawings. Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings to describe illustrative example embodiments are not necessarily mandatory, and some features or steps may be omitted. The order of the steps described in any one of the drawings may be changed as appropriate.

### Configuration

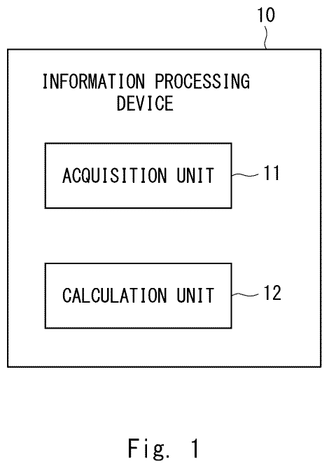

A configuration of an information processing device 10 according to an example embodiment will be described with reference to FIG. 1. FIG. 1 is a diagram illustrating an example of the configuration of the information processing device 10 according to the example embodiment. The information processing device 10 includes an acquisition unit 11 and a calculation unit 12. These units may be achieved by cooperation of one or more programs installed in the information processing device 10 and hardware such as a processor and a memory of the information processing device 10.

The acquisition unit 11 acquires a data set of data including a plurality of feature values indicating features relating to an event (such as a product, for example) and a plurality of evaluation values for the event.

The calculation unit 12 calculates a first range of a first feature value included in the plurality of feature values and a second range of a second feature value included in the plurality of feature values, based on the data set acquired by the acquisition unit 11. The calculation unit 12 also calculates a range of values of each of the plurality of evaluation values in a case where the first feature value is in the first range and the second feature value is in the second range.

### Hardware Configuration

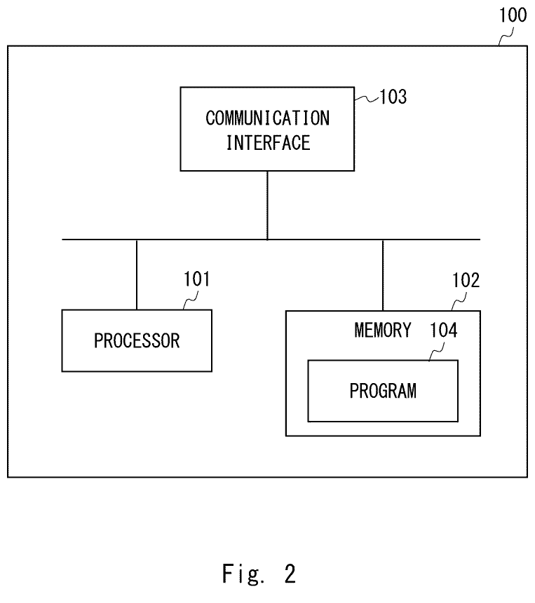

FIG. 2 is a diagram illustrating a hardware configuration example of the information processing device 10 according to the example embodiment. In the example in FIG. 2, the information processing device 10 (computer 100) includes a processor 101, a memory 102, and a communication interface 103. These units may be connected by a bus or the like. The memory 102 stores at least a part of a program 104. The communication interface 103 includes an interface necessary for communication with other network elements.

In a case where the program 104 is executed by the processor 101, the memory 102, and the like in cooperation with each other, at least a part of the process of the example embodiment of the present disclosure is performed by the computer 100. The memory 102 may be of any type. The memory 102 may be a non-transitory computer-readable storage medium, as a non-limiting example. The memory 102 may also be implemented using any appropriate data storage technique such as a semiconductor-based memory device, magnetic memory device and system, optical memory device and system, a fixed memory, and a removable memory. Although only one memory 102 is illustrated in the computer 100, there may be several physically different memory modules in the computer 100. The processor 101 may be of any type. The processor 101 may include one or more of a general purpose computer, a dedicated computer, a microprocessor, a digital signal processor (DSP), and a processor based on a multi-core processor architecture as a non-limiting example. The computer 100 may have a plurality of processors such as an application specific integrated circuit chip that is temporally dependent on a clock that synchronizes a main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, a microprocessor, or other computing devices.

The present disclosure also provides at least one computer program product tangibly stored on a non-transitory computer-readable storage medium. The computer program product includes computer-executable instructions, such as instructions included in a program module, and is executed on a related device on a real or virtual processor to execute the processes or methods of the present disclosure. The program module includes routines, programs, libraries, objects, classes, components, data structures, and the like that, for example, execute specific tasks or implement specific abstract data types. Functions of the program module may be combined or divided between program modules as desired in various example embodiments. A machine-executable instruction of the program module can be executed in a local or distributed device. In the distributed device, the program modules can be located on both local and remote storage media.

A program code for executing the methods of the present disclosure may be written in any combination of one or more programming languages. These program codes are provided to a processor or controller of a general purpose computer, a dedicated computer, or other programmable data processing devices. In a case where the program codes are executed by the processor or controller, the functions/operations in the flowcharts and/or the implemented block diagrams are executed. The program code is executed entirely on a machine, partly on the machine as a stand-alone software package, partly on the machine and partly on a remote machine, or entirely on the remote machine or a server.

The program includes a group of instructions (or a software code) for causing the computer to perform one or more functions described in the example embodiments in a case where the program is loaded into the computer. The program may be stored in a non-transitory computer-readable medium or a tangible storage medium. By way of example and not limitation, the computer-readable medium or the tangible storage medium includes a random-access memory (RAM), a read-only memory (ROM), a flash memory, a solid-state drive (SSD) or any other memory technique, a compact disc read-only memory (CD-ROM), a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. By way of example and not limitation, the transitory computer-readable medium or the communication medium includes electrical, optical, acoustic, or any other form of propagated signals.

### Process

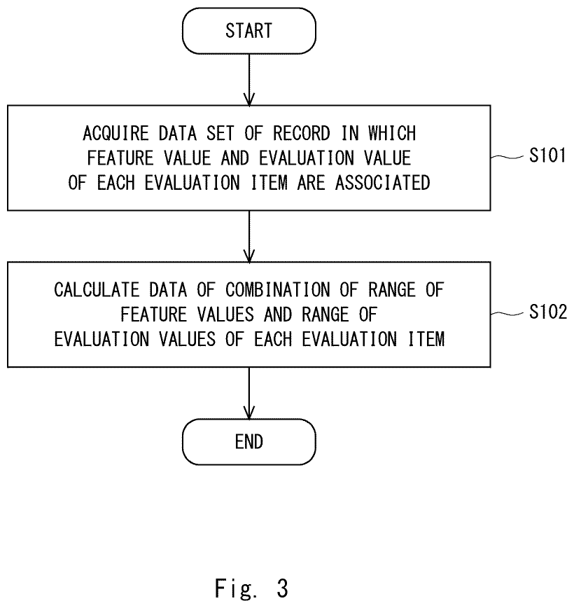

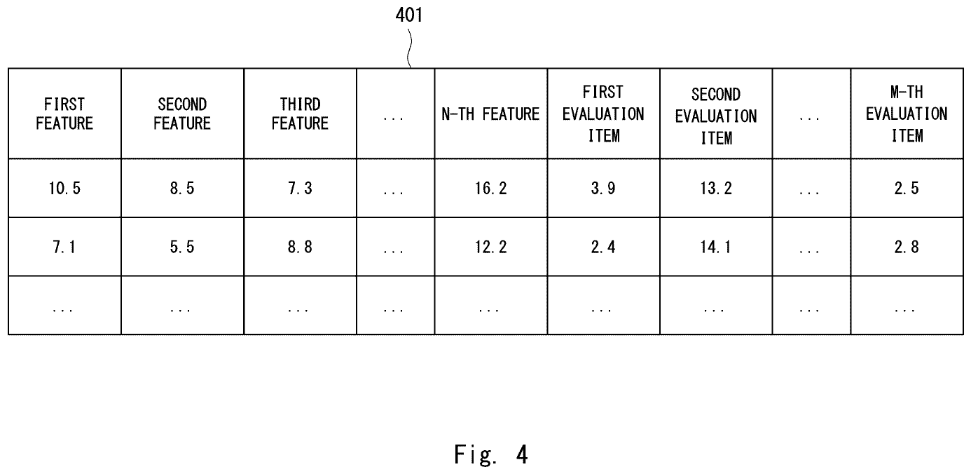

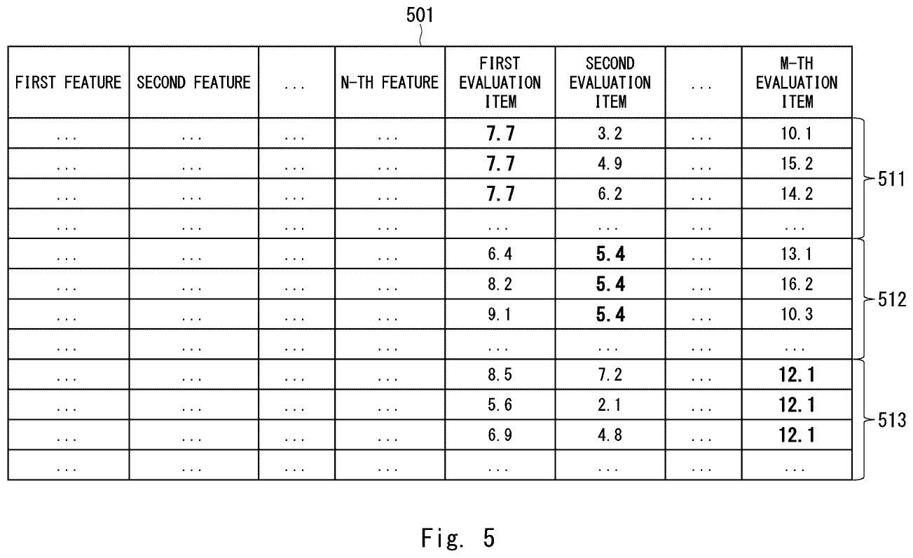

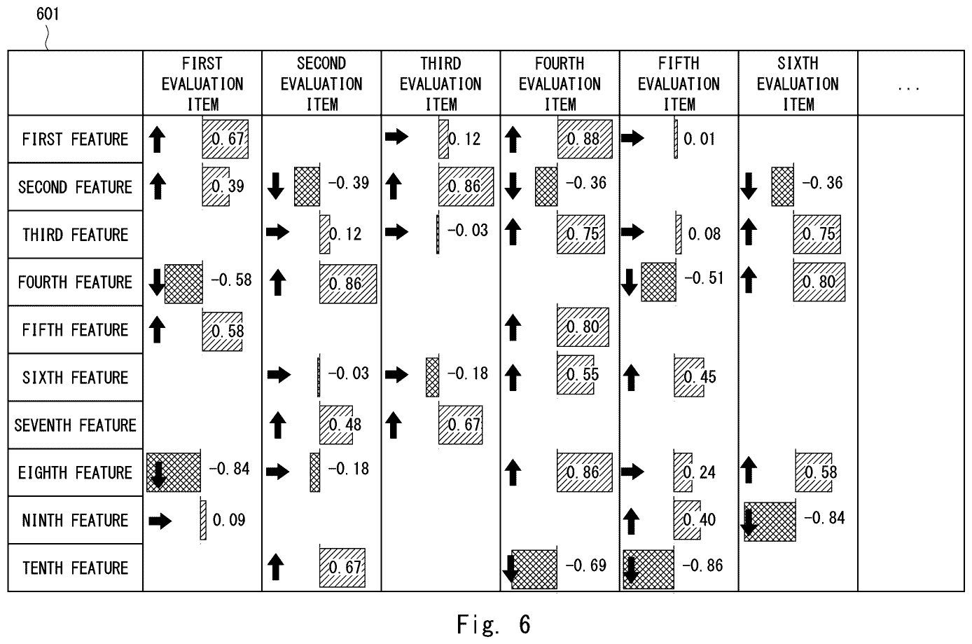

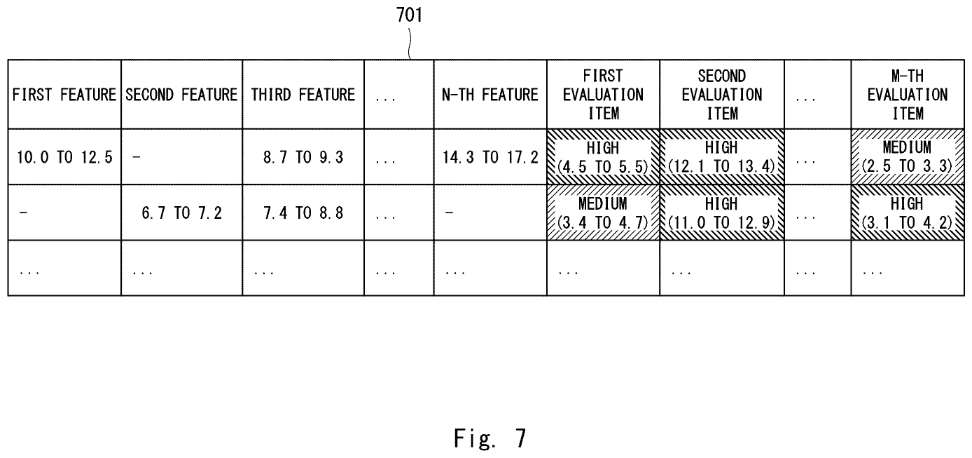

Next, an example of a process of the information processing device 10 according to the example embodiment will be described with reference to FIG. 3 to 7. FIG. 3 is a flowchart illustrating an example of the process of the information processing device 10 according to the example embodiment. FIG. 4 is a diagram illustrating an example of information stored in an evaluation value database (DB) 401 according to the example embodiment. FIG. 5 is a diagram illustrating an example of a process for generating a data set 501 according to the example embodiment. FIG. 6 is a diagram illustrating an example of a display screen 601 according to the example embodiment. FIG. 7 is a diagram illustrating an example of a display screen 701 according to the example embodiment. The process in FIG. 3 may be executed in response to an operation from an operator (administrator), for example.

In step S101, the acquisition unit 11 acquires, from the evaluation value DB 401, a data set of a record in which a plurality of feature values and a plurality of evaluation values corresponding to evaluation items are associated with each other. Note that the evaluation value DB 401 may be recorded in a storage device inside the information processing device 10 or may be recorded in a storage device outside the information processing device 10.

In the example of FIG. 4, an evaluation value DB 401 stores a data set including a plurality of records, each record including a plurality of feature values corresponding to first to N-th features (N is an integer of two or more) and a plurality of evaluation values corresponding to first to M-th evaluation items (M is an integer of two or more). The feature may include, for example, conditions such as a physical quantity, a timing of carrying out work, and a work time that can be set (designated) by a designer by design of a product or the like, and an operating condition of a manufacturing device (also including a condition that is not settable by a person). The evaluation item is performance or the like of a product predicted based on the feature value. The feature is an explanatory variable, and the evaluation item is an objective variable. The feature may include, for example, specifications designated by a designer or a developer, and a value under conditions of a manufacturing device and a peripheral environment (such as temperature and humidity). In a case where the product is a rubber product, the feature may be, for example, an amount of each material, and the evaluation items may be each physical property (such as heat resistance, abrasion resistance, tensile strength, and impact resilience, for example) of the rubber product. Each piece of data recorded in the evaluation value DB 401 may be recorded by combining the following methods with each other as appropriate.

### Example of Generation Based on Actual Measurement

As the data recorded in the evaluation value DB 401, for example, data based on actual measurement may be registered by an operator (administrator) or the like. In this case, the evaluation value can be read as a measurement value, a performance value, or the like.

### Example of Generation by Simulation

The data recorded in the evaluation value DB 401 may be data generated by simulation. In this case, for example, the calculation unit 12 may generate each feature value, based on a random number, and calculate (infer or estimate) each evaluation value, using artificial intelligence (AI), a theoretical formula, or the like, based on each feature value. Then, the calculation unit 12 may record data of a combination of each feature value and each evaluation value in the evaluation value DB 401.

### Example of Generation by Single-Objective Inverse Problem Solver

The data recorded in the evaluation value DB 401 may be data generated by an approach of estimating each feature value with respect to the value of one evaluation item by solving an inverse problem (single-objective inverse problem solver). The inverse problem may be an analytical method for estimating a cause (input) from a result (output) of a certain phenomenon. In this case, for example, the calculation unit 12 may calculate a plurality of combinations of values of feature that attain an ideal value of a specific evaluation item (for example, a first evaluation item) designated by the operator or the like, by solving an inverse problem that attains the ideal value of the specific evaluation item. Here, the calculation unit 12 may solve the inverse problem, using, for example, AI or a mathematical expression. Then, for example, the calculation unit 12 may calculate (infer or estimate) evaluation values of evaluation items (for example, second to M-th evaluation items) other than the specific evaluation item, using AI, for each of the calculated combinations of feature values. The calculation unit 12 then may record a data set of data of a combination of each feature value and each evaluation value in the evaluation value DB 401.

For example, as illustrated in FIG. 5, the calculation unit 12 may also generate a data set 501 of data of a combination of each feature value and each evaluation value by the above-described method for each of ideal values of evaluation items each designated by the operator or the like. In the example in FIG. 5, a record group 511 in a case where the ideal value of the first evaluation item is designated as “7.7”, a record group 512 in a case where the ideal value of the second evaluation item is designated as “5.4”, and a record group 513 in a case where the ideal value of the M-th evaluation item is designated as “12.1” are generated.

Then, the calculation unit 12 may generate a data set of data of a combination of values of feature, based on the data set 501 illustrated in FIG. 5. In this case, the calculation unit 12 may extract a record having a score of each evaluation value equal to or more than a threshold value, among the records included in the data set 501 illustrated in FIG. 5, and record the extracted record in the evaluation value DB 401. As a result, for example, each feature value that gives a relatively good feature value can be acquired. In this case, the calculation unit 12 may normalize each evaluation value and calculate a total value of the normalized evaluation values, as such a score.

The calculation unit 12 may also calculate average values for each feature of a plurality of (two or more) records included in the data set 501 illustrated in FIG. 5. Then, the calculation unit 12 may calculate each evaluation value with respect to the calculated each feature value, using AI or the like. The calculation unit 12 then may record a record of a combination of each feature value and each evaluation value in the evaluation value DB 401. As a result, for example, there is a possibility that each feature value that gives a relatively good value of each evaluation value can be acquired.

### Example of Generation by Multi-Objective Inverse Problem Solver

The data recorded in the evaluation value DB 401 may be data generated by an approach of estimating each feature value with respect to values of a plurality of evaluation items by solving an inverse problem (multi-objective inverse problem solver). In this case, for example, the calculation unit 12 may calculate a plurality of combinations of values of feature that attain an ideal value of each evaluation item designated by the operator or the like, by solving an inverse problem that attains the ideal value of each evaluation item. Here, the calculation unit 12 may solve the inverse problem, using, for example, AI or evolutionary computation. The calculation unit 12 then may record a data set of data of a combination of each feature value and each evaluation value in the evaluation value DB 401.

Example of Using Value between Values of Feature Generated by at Least One of Single-Objective Inverse Problem Solver and Multi-Objective Inverse Problem Solver

The data recorded in the evaluation value DB 401 may be data based on a value between values of each feature generated by at least one of the single-objective inverse problem solver and the multi-objective inverse problem solver. In a case where the explanatory variable (feature) is searched for with the inverse problem for each objective variable (each evaluation value), the value of each explanatory variable suitable for each objective variable is calculated, such as the value of each explanatory variable suitable for the first objective variable, the value of each explanatory variable suitable for the second objective variable, and the value of each explanatory variable suitable for the third objective variable. Therefore, in a case where the first objective variable and the third objective variable are in a trade-off relationship, there is a possibility that a value of each explanatory variable that can achieve a value between the ideal value of the first objective variable and the ideal value of the third objective variable may not be produced as a record.

By generating data of a value between values of each feature generated by at least one of the single-objective inverse problem solver and the multi-objective inverse problem solver, a record including a value of each explanatory variable that can achieve a value between the evaluation values in a trade-off relationship can be generated. In this case, for example, the calculation unit 12 may calculate a plurality of combinations (records) of the feature values that attain the ideal value of each evaluation item, with at least one of the single-objective inverse problem solver and the multi-objective inverse problem solver described above. Then, for example, the calculation unit 12 may calculate a value between values of each feature included in the plurality of records. This value between values may be, for example, a representative value (such as an average value, a median value, or a mode value). Then, the calculation unit 12 may calculate each evaluation value according to each feature value by solving a forward problem. The forward problem may be an analytical method for estimating a result (output) from a cause (input) of a certain phenomenon. The calculation unit 12 then may record a data set of data of a combination of each feature value and each evaluation value in the evaluation value DB 401.

### Example of Making Degree of Influence of Feature Value on Evaluation Value Graspable

The calculation unit 12 may make the degree of influence of the feature value on the evaluation value graspable. As a result, for example, a user is allowed to appropriately grasp which feature value the evaluation value of a certain evaluation item depends on.

In this case, for example, the calculation unit 12 may calculate the degree of influence of each feature on each evaluation item, based on a data set recorded in the evaluation value DB 401. For example, the calculation unit 12 may calculate the degree of influence of each feature on each evaluation item by solving a forward problem formula or using AI or the like. Here, for example, the calculation unit 12 may calculate the degree of contribution or a correlation coefficient as the degree of influence.

In the example in FIG. 6, the value of the degree of influence (such as a correlation coefficient or a degree of importance (permutation importance)) of each feature on each evaluation item (performance) is displayed on a display screen 601. In the example in FIG. 6, an upward arrow is displayed in a case where there is a positive correlation, a downward arrow is displayed in a case where there is a negative correlation, and a rightward arrow is displayed in a case where the correlation is equal to or less than a threshold value. In the example in FIG. 6, for example, it is indicated that the first evaluation item has a positive correlation with the first feature and the value of the degree of influence is “0.67”.

Subsequently, the calculation unit 12 calculates data of a combination of a range of each feature value and a range of evaluation values of each evaluation item, based on the data set acquired by the acquisition unit 11 (step S102). Here, for example, the calculation unit 12 may learn a rule indicating a condition of each evaluation value for a combination of conditions of values of feature, based on the data set acquired by the acquisition unit 11. Then, for example, the calculation unit 12 may calculate data of a combination of a range of each feature value and a range of evaluation values of each evaluation item that match a learned specific rule, among pieces of the data included in the data set acquired by the acquisition unit 11.

In this case, for example, the calculation unit 12 may perform supervised learning, based on a data set recorded in the evaluation value DB 401, and generate a trained model (a black box model BM that is a model whose behavior is difficult to understand due to a complicated internal structure). Then, the calculation unit 12 may learn, for example, a rule set according to the above trained model. The technique used to learn the rule set may be a technique for narrowing down rules included in a decision tree formed by a random forest to appropriate rules and preparing a list of rules called a “decision list”.

As an example of an approach for discovering a rule, for example, the calculation unit 12 may find a proxy rule RR for the black box model BM from a rule set RS that is set (designated or registered) in advance in the information processing device 10 and is constituted by a simple rule that can be understood by a human. As such an approach, the calculation unit 12 may use, for example, the approach described in JP 7435801 B2.

Here, the calculation unit 12 may learn a rule for outputting a second evaluation value (objective function Y) closest to a first evaluation value by the black box model BM with respect to a combination of values of specific feature, among the rules included in the set rule set RS. In this case, the calculation unit 12 may calculate the evaluation value by the black box model BM, based on a combination of feature values included in the data set acquired by the acquisition unit 11. Then, the calculation unit 12 may separately calculate evaluation values according to each rule included in the rule set RS, based on the above combination of feature values. The calculation unit 12 then treats a rule that outputs the second evaluation value closest to the first evaluation value by the black box model BM, as the proxy rule RR, among the rules included in the rule set RS. Therefore, the proxy rule RR is a rule with high interpretability that outputs almost the same evaluation value as that of the black box model BM. In this way, the content of the black box model BM is not understandable by a human, but the human can indirectly trust the evaluation value of the black box model BM by understanding the content of the proxy rule RR that outputs almost the same evaluation value as the black box model BM.

In this case, the calculation unit 12 may calculate a normalized (standardized) total value of the objective function Yᵢ of each evaluation item, as the integrated objective function Y, by following Formula (1).

Y=Y₁+Y₂+ . . . +Y_{N} . . . (1)

The calculation unit 12 may also calculate, as the integrated objective function Y, a normalized (standardized) total value of values obtained by multiplying the objective function Yᵢ of each evaluation item by a weighting factor aᵢ depending on the degree of importance or the like, by following Formula (2).

Y=a₁Y₁+a₂Y₂+ . . . +a_{N}Y_{N} . . . (2)

Then, the calculation unit 12 may learn each rule according to the value of the objective function Y. For example, the calculation unit 12 then may classify records included in the data set recorded in the evaluation value DB 401 into record groups matching each rule.

Then, based on a record group matching a specific rule, as illustrated in FIG. 7, the calculation unit 12 may display a range of each feature value matching a rule for each rule, a range of evaluation values of each evaluation item with the values of each feature matching a rule for each rule, and the like on the display screen. The example in FIG. 7 illustrates, on a display screen 701, that, in a record group matching a certain rule, the range of the first feature value is 10.0 to 12.5, the range of the third feature value is 8.7 to 9.3, and the range of the N-th feature value is 14.3 to 17.2. In the record group matching the certain rule, it is also indicated that the range of evaluation values of the first evaluation item is 4.5 to 5.5, the range of evaluation values of the second evaluation item is 12.1 to 13.4, and the range of evaluation values of the M-th evaluation item is 2.5 to 3.3. As a result, the user (designer) can understand conditions of feature values that simultaneously raise the values of a plurality of evaluation items. The user can also grasp in what value range each of a plurality of feature values is supposed to be set.

In the example in FIG. 7, the level of the evaluation value of each evaluation item is indicated by “high”, “medium”, and so forth. The calculation unit 12 may determine the level, based on a representative value (an average value, a mode value, or a median value) of evaluation values of each evaluation item. For example, the calculation unit 12 may also display the representative value and a standard deviation of evaluation values of each evaluation item in association with the range of each feature value under the specific rule, based on the record group matching the specific rule.

In actual product development, in a case where an evaluation value of a certain evaluation item is relatively good, an evaluation value of another evaluation item may sometimes be in a trade-off relationship in which the evaluation value of the another evaluation item becomes relatively poor. According to the technique of the present disclosure, the user can be supported in choosing a solution that attains a trade-off that can be deemed to be best in practical use, by visualization or clustering in accordance with rules.

### Example of Analyzing Designated Rule in Detail

The calculation unit 12 may conduct more detailed analysis on a rule designated by the user and generate a more detailed rule (sub-rule). As a result, for example, the user can grasp, in more detail, in what value range each of the plurality of feature values is supposed to be set.

In this case, the calculation unit 12 may learn a sub-rule indicating a condition of each evaluation value for a combination of conditions of values of feature, based on a specific data set matching a specific rule designated by the user. Then, the calculation unit 12 may calculate data of a combination of a range of each feature value and a range of evaluation values of each evaluation item that match a learned specific sub-rule, among pieces of the data included in the specific data set.

In this case, for example, the calculation unit 12 may generate each feature value, based on a random number or the like within the range of each feature value that matches a rule designated by the user, and calculate each evaluation value, based on each feature value, using AI, a theoretical formula, or the like. Then, the calculation unit 12 may record data of a combination of each feature value and each evaluation value in the evaluation value DB 401. The calculation unit 12 then may learn a sub-rule indicating a condition of each evaluation value for a combination of conditions of values of feature, based on the data set recorded in the evaluation value DB 401. Then, for example, the calculation unit 12 may calculate data of a combination of a range of each feature value and a range of evaluation values of each evaluation item that match the learned specific sub-rule, among pieces of the data included in the data set acquired by the acquisition unit 11.

### Example of Calculating Degree of Influence for Each Rule

The calculation unit 12 may calculate the degree of influence for each rule. As a result, for example, the user can grasp the degree of influence of each feature on each evaluation item within the range of each feature value that matches a rule designated by the user. In this case, for example, in a case where a specific rule is designated by the user on the display screen 701 in FIG. 7, the calculation unit 12 may extract a record group matching the specific rule from the data set recorded in the evaluation value DB 401. Then, the calculation unit 12 may calculate the degree of influence of each feature on each evaluation item, based on the extracted record group.

### Modified Example

The information processing device 10 may be a device included in one housing, but the information processing device 10 of the present disclosure is not limited thereto. Each unit of the information processing device 10 may be achieved by, for example, cloud computing including one or more computers. Such an information processing device 10 is also included in an example of the “information processing device” according to the present disclosure.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

Some or all of the above-described example embodiments may be described as the following Supplementary Notes, but are not limited to the following. Some or all of the elements (for example, configurations and functions) described in each Supplementary Note dependent on Supplementary Note 1 can also be dependent on an independent Supplementary Note of another category in a similar dependency relationship. Some or all of the elements described in any Supplementary Note may be applied to various types of hardware, software, recording means for recording software, systems, and methods.

### Supplementary Note 1

An information processing device including:
an acquisition unit that acquires a data set of data including a plurality of feature values indicating features relating to an event and a plurality of evaluation values for the event; and
a calculation unit that calculates, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

### Supplementary Note 2

The information processing device according to Supplementary Note 1, in which the calculation unit learns a rule indicating a condition of each of the evaluation values for a combination of conditions of feature values, based on the data set, and calculates a range of the first feature value, a range of the second feature value, and a range of values of each of the plurality of evaluation values that match a specific rule that has been learned, among pieces of data included in the data set.

### Supplementary Note 3

The information processing device according to Supplementary Note 2, in which the calculation unit learns, as the specific rule, a rule that outputs a second evaluation value closest to a first evaluation value by a trained model generated by supervised learning based on the data set, with respect to a combination of values of specific feature, among rules included in the set rule set.

### Supplementary Note 4

The information processing device according to Supplementary Note 3, in which the second evaluation value is a total value of values obtained by normalizing each of values of the plurality of evaluation values or a total value of values obtained by multiplying the values obtained by normalizing each of the values of the plurality of evaluation values, by a designated weighting factor of a degree of importance.

### Supplementary Note 5

The information processing device according to any one of Supplementary Notes 1 to 4, in which the calculation unit includes, in the data set, a record based on a value between feature values generated by at least one of a single-objective inverse problem solver and a multi-objective inverse problem solver.

### Supplementary Note 6

The information processing device according to Supplementary Note 2 or 3, in which the calculation unit learns a sub-rule indicating a condition of each of the evaluation values for a combination of conditions of feature values, based on a specific data set that matches the specific rule designated by a user, and calculates a range of the first feature value, a range of the second feature value, and a value of each of the plurality of evaluation values that match a specific sub-rule that has been learned, among pieces of data included in the specific data set.

### Supplementary Note 7

The information processing device according to any one of Supplementary Notes 1 to 6, in which the calculation unit calculates a degree of influence of each of the first feature and the second feature on each of the first prediction item and the second prediction item, based on the data set.

### Supplementary Note 8

An information processing device including:
an acquisition unit that acquires a data set of data including a plurality of feature values indicating features relating to an event and a plurality of evaluation values for the event; and
a calculation unit that calculates, based on the data set, a degree of influence of each of a first feature and a second feature included in the plurality of feature values on each of the plurality of evaluation values for the event.

### Supplementary Note 9

An information processing method including:
acquiring a data set of data including a plurality of feature values indicating features relating to an event and a plurality of evaluation values for the event; and
calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

### Supplementary Note 10

An information processing method including:
acquiring a data set of data including a plurality of feature values indicating features relating to an event and a plurality of evaluation values for the event; and
calculating, based on the data set, a degree of influence of each of a first feature and a second feature included in the plurality of feature values on each of the plurality of evaluation values for the event.

### Supplementary Note 11

A program for causing a computer to execute a process including:
acquiring a data set of data including a plurality of feature values indicating features relating to an event and a plurality of evaluation values for the event; and
calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

### Supplementary Note 12

A program for causing a computer to execute a process including:
acquiring a data set of data including a plurality of feature values indicating features relating to an event and a plurality of evaluation values for the event; and
calculating, based on the data set, a degree of influence of each of a first feature and a second feature included in the plurality of feature values on each of the plurality of evaluation values for the event.

1. An information processing device comprising:
at least one memory storing instructions; and
at least one processor configured to execute the instructions to;
acquire a data set of data including a plurality of feature values indicating features relating to an event and a plurality of evaluation values for the event; and
calculate, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

2. The information processing device according to claim 1, wherein the at least one processor is further configured to execute the instructions to:
learn a rule indicating a condition of each of the evaluation values for a combination of conditions of feature values, based on the data set,
calculate a range of the first feature value, a range of the second feature value, and a range of values of each of the plurality of evaluation values that match a specific rule that has been learned, among pieces of data included in the data set.

3. The information processing device according to claim 2, wherein the at least one processor is further configured to execute the instructions to:
learn, as the specific rule, a rule that outputs a second evaluation value closest to a first evaluation value by a trained model generated by supervised learning based on the data set, with respect to a combination of values of specific feature, among rules included in the set rule set.

4. The information processing device according to claim 3, wherein the second evaluation value is a total value of values obtained by normalizing each of values of the plurality of evaluation values or a total value of values obtained by multiplying the values obtained by normalizing each of the values of the plurality of evaluation values, by a designated weighting factor of a degree of importance.

5. The information processing device according to claim 1, wherein the at least one processor is further configured to execute the instructions to:
include, in the data set, a record based on a value between feature values generated by at least one of a single-objective inverse problem solver and a multi-objective inverse problem solver.

6. The information processing device according to claim 2, wherein the at least one processor is further configured to execute the instructions to:
learn a sub-rule indicating a condition of each of the evaluation values for a combination of conditions of feature values, based on a specific data set that matches the specific rule designated by a use; and
calculate a range of the first feature value, a range of the second feature, and a value of each of the plurality of evaluation values that match a specific sub-rule that has been learned, among pieces of data included in the specific data set.

7. The information processing device according to claim 1, wherein the at least one processor is further configured to execute the instructions to:
calculate a degree of influence of each of the first feature and the second feature on each of the first prediction item and the second prediction item, based on the data set.

8. An information processing method comprising:
acquiring a data set of data including a plurality of feature values indicating features relating to an event and a plurality of evaluation values for the event; and
calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.

9. A non-transitory computer-readable medium storing an information processing program for causing a computer to perform:
acquiring processing of acquiring a data set of data including a plurality of feature values indicating features relating to an event and a plurality of evaluation values for the event; and
calculating processing of calculating, based on the data set, a first range of a first feature value included in the plurality of feature values, a second range of a second feature value included in the plurality of feature values, and a range of values of each of the plurality of evaluation values in a case where the first feature value is in the first range and the second feature value is in the second range.
